(19) United States
(12) Patent Application Publication
(10) Pub. No.: US 2024/0092658 A1
(43) Pub. Date: Mar. 21, 2024

(54) METHOD FOR MANUFACTURING POSITIVE ELECTRODE ACTIVE MATERIAL, SECONDARY BATTERY, AND VEHICLE

(71) Applicant: SEMICONDUCTOR ENERGY LABORATORY CO., LTD., Atsugi-shi, Kanagawa-ken (JP)

(72) Inventors: Yusuke YOSHITANI, Isehara, Kanagawa (JP); Takashi HIRAHARA, Atsugi, Kanagawa (JP); Noriko MIYAIRI, Hadano, Kanagawa (JP); Masahiko HAYAKAWA, Atsugi, Kanagawa (JP); Yohei MOMMA, Isehara, Kanagawa (JP)

(21) Appl. No.: 18/264,266

(22) PCT Filed: Feb. 1, 2022
(86) PCT No.: PCT/IB2022/050839

§ 371 Date: Aug. 4, 2023

(30) Foreign Application Priority Data
Feb. 12, 2021 (JP) 2021-020922

(51) Int. Cl. C01G 53/00

(52) U.S. Cl. CPC C01G 53/50

(57) ABSTRACT

A positive electrode active material with high charge and discharge capacity is provided. A novel positive electrode active material is provided. The positive electrode active material is manufactured in such a manner that after a cobalt compound (also referred to as a precursor) containing nickel, cobalt, and manganese is obtained by a coprecipitation method, a mixture obtained by mixing a lithium compound and the cobalt compound is heated at a first temperature; after the mixture is ground or crushed, heating at a second temperature that is a temperature higher than the first temperature is further performed; and after an additive is mixed, third heat treatment is performed. The first temperature is higher than or equal to 400° C. and lower than or equal to 700° C. The second temperature is higher than 700° C. and lower than or equal to 1050° C.

### TECHNICAL FIELD

One embodiment of the present invention relates to a positive electrode active material, a secondary battery, and a manufacturing method thereof. One embodiment of the present invention relates to a portable information terminal and a vehicle each including a secondary battery.

One embodiment of the present invention relates to an object or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that semiconductor devices in this specification mean all devices that can function by utilizing semiconductor characteristics, and an electro-optical device, a semiconductor circuit, and an electronic device are all semiconductor devices.

Note that power storage devices in this specification refer to any elements and devices having a function of storing power. For example, a power storage device (also referred to as a secondary battery) such as a lithium-ion secondary battery, a lithium-ion capacitor, and an electric double layer capacitor are included.

### BACKGROUND ART

In recent years, lithium-ion secondary batteries, lithium-ion capacitors, air batteries, or a variety of power storage devices have been actively developed. In particular, demand for lithium-ion secondary batteries with high output and high energy density has rapidly grown with the development of the semiconductor industry, for portable information terminals typified by mobile phones, smartphones, and laptop computers, portable music players, digital cameras, medical equipment, next-generation clean energy vehicles typified by hybrid electric vehicles (HVs), electric vehicles (EVs), and plug-in hybrid electric vehicles (PHVs), and the like, and the lithium-ion secondary batteries are essential for today's information society as rechargeable energy supply sources.

Patent Document 1 discloses a positive electrode active material for a lithium-ion secondary battery with high capacity and excellent charge and discharge cycle performance.

### REFERENCE

### Patent Document

[Patent Document 1] WO2020/099978

### SUMMARY OF THE INVENTION

### Problems to be Solved by the Invention

An object of one embodiment of the present invention is to provide a positive electrode active material with high charge and discharge capacity. Another object is to provide a positive electrode active material with high charge and discharge voltage. Another object is to provide a positive electrode active material that hardly deteriorates. Another object is to provide a novel positive electrode active material. Another object is to provide a secondary battery with high charge and discharge capacity. Another object is to provide a secondary battery with high charge and discharge voltage. Another object is to provide a highly safe or reliable secondary battery. Another object is to provide a secondary battery that hardly deteriorates. Another object is to provide a long-life secondary battery. Another object is to provide a novel secondary battery.

Another object of one embodiment of the present invention is to provide a novel material, a novel active material, a novel power storage device, or a manufacturing method thereof.

Note that the description of these objects does not preclude the existence of other objects. One embodiment of the present invention does not have to achieve all of these objects. Other objects can be derived from the description of the specification, the drawings, and the claims.

### Means for Solving the Problems

In a structure of the invention regarding the method disclosed in this specification, a positive electrode active material is manufactured in such a manner that after a cobalt compound (also referred to as a precursor) containing nickel, cobalt, and manganese is obtained by a coprecipitation method, a mixture obtained by mixing the cobalt compound and a lithium compound is heated at a first temperature and, after the heated mixture is ground or crushed, heating at a second temperature that is a temperature higher than the first temperature is further performed.

Moisture is released by the heating at the first temperature, and then heating is performed at the second temperature that is higher than the first temperature. Performing the heat treatment twice can improve the mixing state of the mixture, and when a secondary battery is fabricated with the mixture, voids of secondary particles can be reduced. Furthermore, the twice heat treatments can improve the crystallinity.

The first temperature is higher than or equal to 400° C. and lower than or equal to 700° C.

The second temperature is higher than 700° C. and lower than or equal to 1050° C.

In the case where aluminum is added as an additive element to the mixture, the lithium compound is added before the heat treatment at the first temperature, an aluminum compound is added after the second heat treatment, and third heat treatment is performed.

In a method for manufacturing a positive electrode active material, an aqueous solution in which a water-soluble nickel salt, a water-soluble cobalt salt, and a water-soluble manganese salt are dissolved and an alkaline solution are supplied to a reaction vessel and mixed in the reaction vessel to precipitate a cobalt compound; a first mixture of the cobalt compound and a lithium compound is heated at a first temperature; after the first mixture is ground or crushed, heating is further performed at a second temperature that is a temperature higher than the first temperature; and a second mixture obtained by mixing the first mixture and an aluminum compound is heated at a third temperature.

By the coprecipitation method for precipitating the cobalt compound, the aqueous solution in which the water-soluble nickel salt, the water-soluble cobalt salt, and the water-soluble manganese salt are dissolved and the alkaline solution are supplied to the reaction vessel, and mixing is performed in the reaction vessel to precipitate the cobalt compound (hydroxide containing cobalt, manganese, and nickel). The reaction is referred to as a neutralization reaction, an acid-base reaction, or a coprecipitation reaction in some cases. The compound containing at least nickel, cobalt, and manganese is referred to as a cobalt compound or a precursor of lithium cobalt oxide in some cases regardless of the contained amount of cobalt. The cobalt compound (hydroxide containing cobalt, manganese, and nickel) obtained by a coprecipitation reaction is referred to as a precursor in some cases. Then, a mixture of the cobalt compound and the lithium compound is obtained.

As the aqueous solution in which the water-soluble nickel salt is dissolved, a nickel sulfate aqueous solution or a nickel nitrate aqueous solution can be used.

As the aqueous solution in which the water-soluble cobalt salt is dissolved, a cobalt sulfate aqueous solution or a cobalt nitrate aqueous solution can be used.

As the aqueous solution in which the water-soluble manganese salt is dissolved, a manganese sulfate aqueous solution or a manganese nitrate aqueous solution can be used.

In the case where aluminum is further added as an additive element to the mixture, an aqueous solution containing aluminum is further supplied to the reaction vessel. In the case where magnesium is added as an additive element to the mixture, an aqueous solution containing magnesium is further supplied to the reaction vessel. In the case where calcium is added as an additive element to the mixture, an aqueous solution containing calcium is further supplied to the reaction vessel.

Moreover, the pH in the reaction vessel is preferably greater than or equal to 9.0 and less than or equal to 11.0, further preferably greater than or equal to 10.0 and less than or equal to 10.5.

When the aqueous solution and the alkaline solution are mixed to precipitate the cobalt compound, a chelating agent is added. Examples of the chelating agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. The chelating agent is dissolved in pure water, which is used as a chelate aqueous solution. The chelating agent serves as a complexing agent to form a chelate compound, and is preferred to a general complexing agent. Needless to say, such a complexing agent may be used instead of the chelating agent, and a general complexing agent such as an ammonia aqueous solution can be used.

The use of the chelate aqueous solution is preferable because it is easy to control the pH in the reaction vessel for obtaining a cobalt compound. Furthermore, the use of the chelate aqueous solution is preferable also because the chelate aqueous solution suppresses generation of unnecessary crystal nuclei and promotes crystal growth. Since generation of unnecessary crystal nuclei is suppressed to inhibit generation of fine particles, a hydroxide with good particle size distribution can be obtained. Furthermore, the use of the chelate aqueous solution can slow an acid-base reaction, so that the reaction gradually progresses to form a nearly spherical secondary particle. Glycine has a function of keeping the pH greater than or equal to 9.0 and less than or equal to 10.0 or the vicinity of the range. Using a glycine aqueous solution as the chelate aqueous solution is preferable because it is easy to control the pH of the reaction vessel when obtaining the cobalt compound. Furthermore, the concentration of glycine in the glycine aqueous solution is preferably greater than or equal to 0.05 mol/L and less than or equal to 0.09 mol/L in the aqueous solution in which the transition metal salts are dissolved.

The positive electrode active material obtained by the above-described method includes crystal having a hexagonal crystal layered structure. The crystal is not limited to a single crystal (also referred to as a crystallite). In the case where the crystal is polycrystalline, some crystallites gather to form a primary particle. The primary particle indicates a particle recognized as a single grain when observed with a SEM. The secondary particle indicates a group of aggregated primary particles. For the aggregation of the primary particles, there is no particular limitation on the bonding force between the plurality of primary particles. The bonding force may be any of covalent bonding, ionic bonding, a hydrophobic interaction, the Van der Waals force, and other molecular interactions, or a plurality of bonding forces may work together.

When the coprecipitation method is employed, the secondary particle is formed in some cases.

The crystal having a hexagonal crystal layered structure includes one or more selected from a first transition metal, a second transition metal, and a third transition metal. Specifically, NiCoMn-based material (also referred to as NCM) represented by LiNiₓCo_{y}Mn_{z}O₂ (x>0, y>0, z>0, 0.8<x+y+z<1.2) where the first transition metal is nickel, the second transition metal is cobalt, and the third transition metal is manganese, can be used. Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=9:0.5:0.5 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

The positive electrode active material obtained in the above-described method may contain one or more selected from a group formed of Al, Mg, Ca, Zr, V, Cr, Fe, Cu, Zn, Ga, Ge, Sr, Y, Nb, Mo, Sn, Ba, and La as necessary, in addition to the first transition metal, the second transition metal, and the third transition metal. In order that a secondary battery including the positive electrode active material has higher capacity retention rate after charge and discharge cycles, the positive electrode active material preferably contains Al, Mg, Ca, or Zr.

The secondary battery including the positive electrode active material is also a structure disclosed in this specification. The secondary battery includes a positive electrode including the positive electrode active material and a negative electrode including a negative electrode active material. In addition, a separator is included between the positive electrode and the negative electrode. The separator is used for preventing short circuit; thus, a secondary battery with high safety or high reliability can be provided.

In the case where aluminum is added as an additive element to the positive electrode active material, when the above-described method is regarded as the first method, there are other methods. The second method is a method in which aluminum is added in a state of an oxide before the first heat treatment. The third method is a method using an aqueous solution containing aluminum as one of aqueous solutions used for the coprecipitation method.

As described above, there are three methods of adding aluminum as an additive element to the positive electrode active material. In the case where aluminum is added as an additive element to the positive electrode active material, one or more of the above-described three methods can be employed. For example, in the case where a large amount of aluminum is added, the following procedure is possible: after aluminum is added with use of an aluminum-containing aqueous solution at the time of the coprecipitation method, lithium and aluminum are added and mixed; after heating is performed at a first temperature to release moisture, heating is performed at a second temperature that is higher than the first temperature; aluminum is added after the second heating; and then third heating is performed.

### Effect of the Invention

Performing heat treatment twice in one embodiment of the present invention improves the mixing state of the mixture, which can reduce voids of secondary particles when a secondary battery is fabricated. In addition, performing heat treatment three times, two times before the addition of aluminum and one time after the addition, can improve the crystallinity. Thus, a positive electrode active material with high capacity can be provided. A positive electrode active material which is relatively stable even when charge and discharge are repeated can be provided. A highly safe or highly reliable secondary battery can be provided.

Note that the description of these effects does not preclude the existence of other effects. One embodiment of the present invention does not need to have all of these effects. Other effects will be apparent from the description of the specification, the drawings, and the claims, and other effects can be derived from the description of the specification, the drawings, and the claims.

### BRIEF DESCRIPTION OF THE DRAWINGS

FIG. 1 is a diagram illustrating an example of a flow chart for manufacturing a positive electrode active material showing one embodiment of the present invention.

FIG. 2 is a diagram illustrating an example of a flow chart for manufacturing a positive electrode active material showing one embodiment of the present invention.

FIG. 3 is a cross-sectional view illustrating a reaction vessel used for one embodiment of the present invention.

FIG. 4A is an exploded perspective view of a coin-type secondary battery, FIG. 4B is a perspective view of the coin-type secondary battery, and FIG. 4C is a cross-sectional perspective view thereof.

FIG. 5A illustrates an example of a cylindrical secondary battery. FIG. 5B illustrates the example of the cylindrical secondary battery. FIG. 5C illustrates an example of a plurality of cylindrical secondary batteries. FIG. 5D illustrates an example of a power storage system including a plurality of cylindrical secondary batteries.

FIG. 6A and FIG. 6B illustrate examples of a secondary battery, and FIG. 6C is a diagram illustrating the internal state of a secondary battery.

FIG. 7A to FIG. 7C are diagrams illustrating an example of a secondary battery.

FIG. 8A and FIG. 8B are diagrams illustrating external appearances of secondary batteries.

FIG. 9A to FIG. 9C are diagrams illustrating a method for manufacturing a secondary battery.

FIG. 10A to FIG. 10C are diagrams illustrating structure examples of a battery pack.

FIG. 11A and FIG. 11B are diagrams illustrating examples of a secondary battery.

FIG. 12A to FIG. 12C are diagrams illustrating an example of a secondary battery.

FIG. 13A and FIG. 13B are diagrams illustrating an example of a secondary battery.

FIG. 14A is a perspective view of a battery pack of one embodiment of the present invention, FIG. 14B is a block diagram of the battery pack, and FIG. 14C is a block diagram of a vehicle having a motor.

FIG. 15A to FIG. 15D are diagrams illustrating examples of transport vehicles.

FIG. 16A and FIG. 16B are diagrams illustrating power storage devices of one embodiment of the present invention.

FIG. 17A is a diagram illustrating an electric bicycle, FIG. 17B is a diagram illustrating a secondary battery of an electric bicycle, and FIG. 17C is a diagram illustrating an electric motorcycle.

FIG. 18A to FIG. 18D are diagrams illustrating examples of electronic devices.

FIG. 19 is a photograph of an observed cross section of a positive electrode.

FIG. 20 is an enlarged photograph of a part of the observed cross section of the positive electrode.

FIG. 21A and FIG. 21B are graphs illustrating charge and discharge cycle performance of secondary batteries at 25° C.

FIG. 22A and FIG. 22B are graphs illustrating charge and discharge cycle performance of secondary batteries at 45° C.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

### Embodiment 1

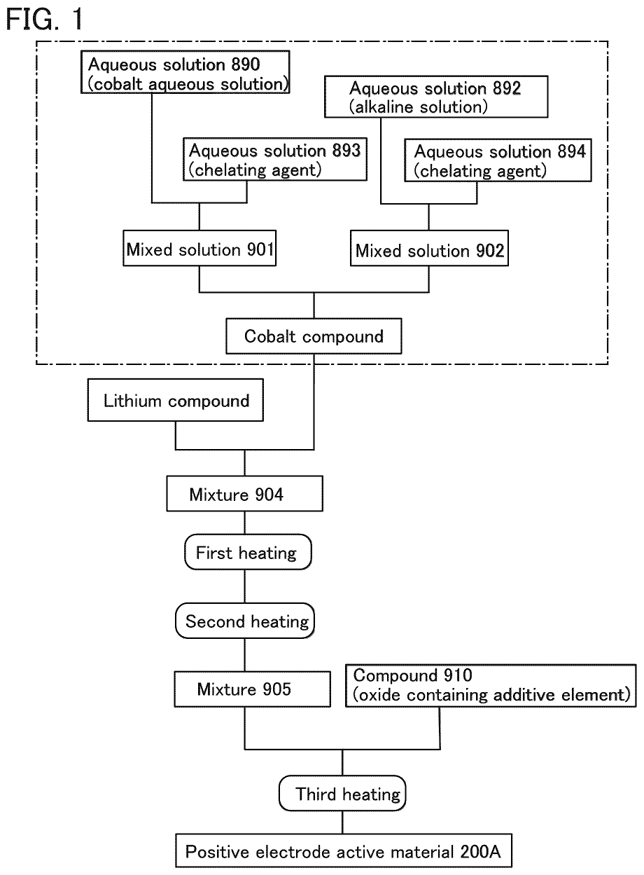

In this embodiment, an example of a method for manufacturing a positive electrode active material 200A in which an additive element is added to a cobalt compound obtained by a coprecipitation method will be described with reference to FIG. 1. Note that the flow chart in FIG. 1 shows the order of components connected with lines. The flow chart does not show timing for the components not directly connected with lines. For example, although formation of a mixed solution 901 and formation of a mixed solution 902 are shown at the same level in FIG. 1, they are not necessarily performed at the same time.

Employed in this embodiment is a process in which a precursor (also referred to as a coprecipitation precursor) where Co, Ni, or Mn exists in one particle is formed by a coprecipitation method, heating is performed twice after a Li salt is mixed to the coprecipitation precursor, and then aluminum is added.

As illustrated in FIG. 1, a cobalt aqueous solution is prepared as an aqueous solution 890, and an alkaline solution is prepared as an aqueous solution 892. The aqueous solution 890 and an aqueous solution 893 are mixed to form the mixed solution 901. The aqueous solution 892 and an aqueous solution 894 are mixed to form the mixed solution 902. These mixed solutions 901 and 902 are made to react to form a cobalt compound. This reaction is referred to as a neutralization reaction, an acid-base reaction, or a coprecipitation reaction, and this cobalt compound is referred to as a precursor of lithium cobalt oxide in some cases. Note that a reaction caused by performing steps surrounded by the chain line in FIG. 1 can be referred to as a coprecipitation reaction.

### <Cobalt Aqueous Solution>

As the cobalt aqueous solution, an aqueous solution containing cobalt sulfate (e.g., CoSO₄), cobalt chloride (e.g., CoCl₂), cobalt nitrate (e.g., Co(NO₃)₂), cobalt acetate (e.g., C₄H₆COO₄), cobalt alkoxide, an organocobalt complex, or hydrate of any of these is given. Alternatively, instead of the cobalt aqueous solution, an organic acid of cobalt, such as cobalt acetate, or hydrate of the organic acid of cobalt may be used. Note that in this specification, the organic acid includes citric acid, oxalic acid, formic acid, and butyric acid, in addition to acetic acid.

For example, an aqueous solution obtained by dissolving these in pure water can be used. The cobalt aqueous solution shows acidity, and thus can be referred to as an acid aqueous solution. The cobalt aqueous solution can be referred to as a cobalt source in a manufacturing process of a positive electrode active material.

### <Nickel Aqueous Solution>

As a nickel aqueous solution, an aqueous solution of nickel sulfate, nickel chloride, nickel nitrate, or hydrate of any of these can be used. Alternatively, an aqueous solution of an organic acid salt of nickel, such as nickel acetate, or hydrate of the organic acid salt of nickel can be used. Alternatively, an aqueous solution of nickel alkoxide or an organonickel complex can be used. The nickel aqueous solution can be referred to as a nickel source in a process of manufacturing a positive electrode active material.

### <Manganese Aqueous Solution>

As a manganese aqueous solution, an aqueous solution of manganese salt, such as manganese sulfate, manganese chloride, or manganese nitrate, or hydrate of any of these can be used. Alternatively, an aqueous solution of an organic acid salt of manganese, such as manganese acetate, or hydrate of the organic acid salt of manganese can be used. Alternatively, an aqueous solution of manganese alkoxide or an organomanganese complex can be used.

The above-described cobalt aqueous solution, nickel aqueous solution, and manganese aqueous solution may be prepared and mixed to form the aqueous solution 890; or nickel sulfate, cobalt sulfate, and manganese sulfate may be mixed and then mixed with water to form the aqueous solution 890, for example.

In this embodiment, nickel sulfate, cobalt sulfate, and manganese sulfate are weighed out to have desired amounts and mixed. The aqueous solution 890 obtained by mixing those is mixed with the aqueous solution 893 to form the mixed solution 901, and the mixed solution 902 of the aqueous solution 892, which is the alkaline solution, and the aqueous solution 894 is formed. As the aqueous solutions 893 and 894, aqueous solutions serving as chelating agents are used; however, the aqueous solutions 893 and 894 are not particularly limited thereto and may be pure water. The manganese aqueous solution can be referred to as a manganese source in a process of manufacturing a positive electrode active material.

### <Alkaline Solution>

As the alkaline solution, an aqueous solution containing sodium hydroxide, potassium hydroxide, lithium hydroxide, or ammonia is given. For example, an aqueous solution obtained by dissolving these in pure water can be used. An aqueous solution in which two or more kinds selected from sodium hydroxide, potassium hydroxide, and lithium hydroxide are dissolved in pure water may be used.

### <Reaction Conditions>

In the case where the aqueous solution 890 and the aqueous solution 892 are made to react by the coprecipitation method, the pH of the reaction system is set to greater than or equal to 9.0 and less than or equal to 11.0, preferably greater than or equal to 9.8 and less than or equal to 10.3. For example, in the case where the aqueous solution 892 is put into a reaction vessel and the aqueous solution 890 is dropped into the reaction vessel, the pH of the aqueous solution in the reaction vessel is preferably kept in the above range. The same applies to the case where the aqueous solution 890 is put into the reaction vessel and the aqueous solution 892 is dropped. The dropping rate of the aqueous solution 890 or the aqueous solution 892 is preferably greater than or equal to 0.1 mL/min. and less than or equal to 0.8 mL/min., in which case the pH condition can be controlled easily. The reaction vessel contains a reaction container.

An aqueous solution in the reaction vessel is preferably stirred with a stirring means. The stirring means includes a stirrer or an agitator blade. Two to six agitator blades can be provided; for example, in the case where four agitator blades are provided, they may be placed in across shape seen from above. The number of rotations of the stirring means is preferably greater than or equal to 800 rpm and less than or equal to 1200 rpm.

The temperature in the reaction vessel is adjusted to be higher than or equal to 50° C. and lower than or equal to 90° C. The dropping of the aqueous solution 892 or the aqueous solution 890 is preferably started after the temperature becomes the above temperature.

The reaction vessel preferably has an inert atmosphere. For example, in the case of a nitrogen atmosphere, a nitrogen gas is preferably introduced at a flow rate of 0.5 L/min. or more and 2 L/min. or less.

In the reaction vessel, a reflux condenser is preferably placed. The nitrogen gas can be released from the reaction vessel and water can be returned to the reaction vessel with use of the reflux condenser.

Through the above reaction, a cobalt compound is precipitated in the reaction vessel. Filtration is performed to collect the cobalt compound. After a reaction product precipitated in the reaction vessel is washed with pure water, an organic solvent (e.g., acetone) having a low boiling point is preferably added before the filtration is performed.

The cobalt compound after the filtration is preferably dried. For example, drying is performed under vacuum at higher than or equal to 60° C. and lower than or equal to 90° C. for longer than or equal to 0.5 hours and shorter than or equal to 3 hours. In this manner, the cobalt compound can be obtained.

The cobalt compound obtained through the above reaction includes cobalt hydroxide (e.g., Co(OH)₂). The cobalt hydroxide after the filtration is obtained in the state of secondary particles which are aggregations of primary particles. Note that in this specification, a primary particle refers to a particle (lump) of the smallest unit having no grain boundary when being observed, for example, at a magnification of 5000 times with a SEM (scanning electron microscope). In other words, the primary particle means a particle of the smallest unit surrounded by a grain boundary. A secondary particle refers to a particle in which the primary particles are aggregated, partially sharing the grain boundary (the circumference of the primary particle), and are not easily separated from each other (a particle independent of the other particles). That is, the secondary particle has a grain boundary in some cases.

Next, a lithium compound is prepared.

### <Lithium Compound>

As the lithium compound, a Li salt such as lithium hydroxide (e.g., LiOH), lithium carbonate (e.g., Li₂CO₃), or lithium nitrate (e.g., LiNO₃) can be given, for example. In particular, a material having a low melting point among lithium compounds, such as lithium hydroxide (melting point: 462° C.), is preferably used. Since a positive electrode active material having a high nickel proportion is likely to cause cation mixing as compared to lithium cobalt oxide, first heating needs to be performed at a low temperature. Therefore, it is preferable to use a material having a low melting point.

In this embodiment, the cobalt compound and the lithium compound are weighed out to have desired amounts and mixed to form a mixture 904. For the mixing, a mortar or a stirring mixer is used.

Next, first heating is performed. An electric furnace or a rotary kiln furnace can be used as a firing device for the first heating.

Then, grinding or crushing is performed with a mortar to loosen the secondary particles fixed one another, and the ground or crushed mixture is collected. Furthermore, classification may be performed using a sieve. In this embodiment, a crucible made of aluminum oxide (also referred to as alumina) with a purity of 99.9% is used. It is suitable to collect the heated materials after the materials are transferred from the crucible to a mortar in order to prevent impurities from entering the materials. The mortar is suitably made of a material which is difficult to release impurities. Specifically, it is suitable to use a mortar made of alumina with a purity of 90% or higher, preferably 99% or higher.

Next, second heating is performed. An electric furnace or a rotary kiln furnace can be used as a firing device for the second heating.

The second temperature is at least higher than the first temperature and is preferably higher than 700° C. and lower than or equal to 1050° C. The time of the second heating is preferably longer than or equal to 1 hour and shorter than or equal to 20 hours. The second heating is preferably performed in an oxygen atmosphere, and in particular, preferably performed while oxygen is supplied. For example, the flow rate is 10 L/min. per liter of inner capacity of the furnace. Specifically, the heating is preferably performed in a state where a container containing the mixture 904 is covered with a lid.

Then, grinding or crushing is performed with a mortar to loosen the secondary particles fixed one another, and the ground or crushed mixture is collected. Furthermore, classification may be performed using a sieve.

Then, an obtained mixture 905 and a compound 910 are mixed.

### <Compound 910>

As an additive element source, one or more selected from an aluminum salt, a magnesium salt, and a calcium salt are used. As the compound 910, one or more selected from aluminum oxide, aluminum hydroxide, magnesium oxide, magnesium hydroxide, basic magnesium carbonate ((MgCO₃)₃Mg(OH)₂.3H₂O), calcium oxide, calcium carbonate, and calcium hydroxide are used. In this embodiment, an aluminum salt is used as the additive element source and aluminum hydroxide (Al(OH)₃) is used as the compound 910. The compound 910 used as the additive element source is weighed out by a practitioner to be appropriately contained in a desired amount. It is desirable that aluminum, magnesium, or calcium be added at higher than or equal to 0.5 atm % and lower than or equal to 3 atm % with respect to the cobalt compound. Note that the concentration of the additive element here is based on the added amount in the formation of the secondary particles and might not correspond to the actually analyzed concentration.

Then, third heating is performed. The third temperature is at least higher than the first temperature and is preferably higher than 700° C. and lower than or equal to 1050° C. The time of the third heating is preferably shorter than that of the second heating and longer than or equal to 1 hour and shorter than or equal to 20 hours. The third heating is preferably performed in an oxygen atmosphere, and in particular, preferably performed while oxygen is supplied. For example, the flow rate is 10 L/min. per liter of inner capacity of the furnace. Specifically, the heating is preferably performed in a state where a container containing the mixture 905 is covered with a lid.

Then, grinding or crushing is performed with a mortar to loosen the secondary particles fixed one another, and the ground or crushed mixture is collected. Furthermore, classification may be performed using a sieve. With the crushing step, the grain size and/or the shape of the positive electrode active material 200A can be uniformized.

Through the above steps, the positive electrode active material 200A can be manufactured. The positive electrode active material 200A obtained through the above steps is Al-added NCM and thus referred to as NCMA in some cases.

### Embodiment 2

One embodiment of the present invention is not limited to the procedure of the steps in FIG. 1. In this embodiment, nickel sulfate, cobalt sulfate, and manganese sulfate are weighed out to have desired amounts and mixed. The mixed solution 901 obtained by mixing those with the aqueous solution 893, the mixed solution 902 of the aqueous solution 892, which is the alkaline solution, and the aqueous solution 894, and a mixed solution 906 obtained by mixing an aqueous solution 896 containing an additive element and an aqueous solution 895 are prepared. As the aqueous solutions 893, 894, and 895, aqueous solutions serving as chelating agents are used; however, the aqueous solutions 893, 894, and 895 are not particularly limited thereto and may be pure water.

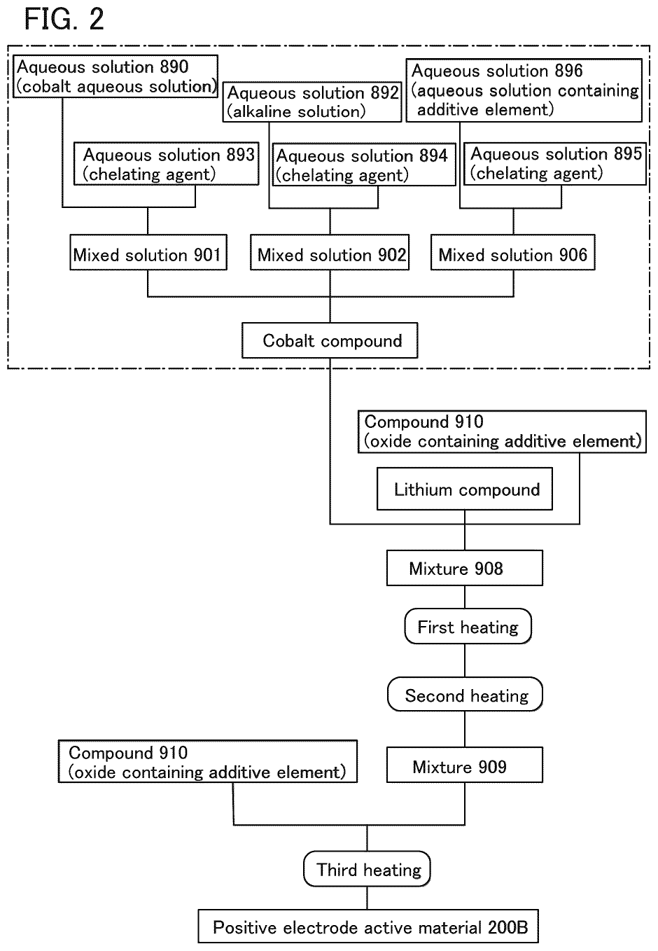

In FIG. 2, the aqueous solution 896 containing an additive element is further used as a material for forming a cobalt compound by a coprecipitation method. In the case where aluminum is added as the additive element, an aqueous solution of aluminum is further supplied to the reaction vessel. In the case where magnesium is added as the additive element to the mixture, an aqueous solution of magnesium is further supplied to the reaction vessel. In the case where calcium is added as the additive element to the mixture, an aqueous solution of calcium is further supplied to the reaction vessel.

Moreover, the pH in the reaction vessel is preferably greater than or equal to 9.0 and less than or equal to 11.0, further preferably greater than or equal to 10.0 and less than or equal to 10.5.

Next, a lithium compound and the compound 910 as an oxide containing an additive element are prepared.

As illustrated in FIG. 2, the cobalt compound obtained by a coprecipitation method and the lithium compound are mixed to form a mixture 908.

After the mixture 908 is obtained, first heating is performed. An electric furnace or a rotary kiln furnace can be used as a firing device for the first heating.

Next, second heating is performed. An electric furnace or a rotary kiln furnace can be used as a firing device for the second heating.

The second temperature is at least higher than the first temperature and is preferably higher than 700° C. and lower than or equal to 1050° C. The time of the second heating is preferably longer than or equal to 1 hour and shorter than or equal to 20 hours. The second heating is preferably performed in an oxygen atmosphere, and in particular, preferably performed while oxygen is supplied. For example, the flow rate is 10 L/min. per liter of inner capacity of the furnace. Specifically, the heating is preferably performed in a state where a container containing the mixture 908 is covered with a lid.

Then, grinding or crushing is performed with a mortar to loosen the secondary particles fixed one another, and the ground or crushed mixture is collected. Furthermore, classification may be performed using a sieve.

Then, an obtained mixture 909 and the compound 910 are mixed.

Then, third heating is performed. The third temperature is at least higher than the first temperature and is preferably higher than 700° C. and lower than or equal to 1050° C. The time of the third heating is preferably longer than or equal to 1 hour and shorter than or equal to 20 hours. The third heating is preferably performed in an oxygen atmosphere, and in particular, preferably performed while oxygen is supplied. For example, the flow rate is 10 L/min. per liter of inner capacity of the furnace. Specifically, the heating is preferably performed in a state where a container containing the mixture 909 is covered with a lid.

Then, grinding or crushing is performed with a mortar to loosen the secondary particles fixed one another, and the ground or crushed mixture is collected. Furthermore, classification may be performed using a sieve. With the crushing step, the grain size and/or the shape of a positive electrode active material 200B can be uniformized.

Through the above steps, the positive electrode active material 200B can be manufactured. Since the process for obtaining the positive electrode active material 200B is partly different from the process for obtaining the positive electrode active material 200A in FIG. 1, the composition of the final product may be different between the manufacturing procedures in FIG. 1 and FIG. 2.

FIG. 2 illustrates an example in which mixing of an additive element is performed three times; however, one embodiment of the present invention is not particularly limited to this. The number of times of mixing an additive element may be one or more. Different kinds of additive elements may be combined. When the manufacturing procedure in FIG. 2 is used, three different kinds of additive elements can be added to the positive electrode active material 200B.

This embodiment can be freely combined with the other embodiments.

### Embodiment 3

In this embodiment, a coprecipitation apparatus that performs a coprecipitation method in the manufacturing methods in Embodiments 1 to 3 is described.

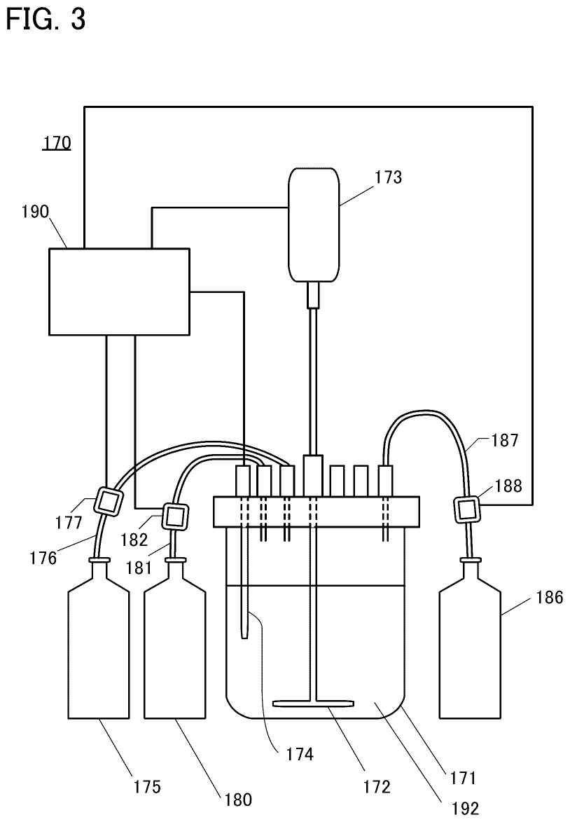

A coprecipitation synthesis apparatus 170 illustrated in FIG. 3 includes a reaction vessel 171, and the reaction vessel 171 includes a reaction container. A separable flask is used in the lower part of the reaction container and a separable cover is used in the upper part of the reaction container. The separable flask may be cylindrical or round type. A cylindrical separable flask has a flat bottom. The atmosphere of the reaction vessel 171 can be controlled with at least one inlet of the separable cover. For example, the atmosphere preferably contains nitrogen. In that case, it is preferable to make nitrogen flow in the reaction vessel 171. Nitrogen is preferably subjected to bubbling in an aqueous solution 192 in the reaction vessel 171. The coprecipitation synthesis apparatus 170 may be equipped with a reflux condenser connected to at least one inlet of the separable cover. This reflux condenser allows an atmosphere gas in the reaction vessel 171, e.g., nitrogen, to be ejected and water to return to the reaction vessel 171. In the atmosphere of the reaction vessel 171, it is acceptable that the amount of streaming air necessary for ejecting a gas generated by a pyrolytic reaction due to heat treatment is maintained.

The procedure of a coprecipitation method surrounded by the chain line in FIG. 1 is described with reference to FIG. 1 and FIG. 3.

First, the aqueous solution 894 (chelating agent) is put in the reaction vessel 171, and then the mixed solution 901 and the aqueous solution 892 (alkaline solution) are dropped into the reaction vessel 171. The aqueous solution 192 in FIG. 3 is in the state where dropping has started. Note that the aqueous solution 894 is sometimes referred to as a filling liquid. The filling liquid is described as an adjustment liquid, and denotes an aqueous solution before a reaction, that is, an initial aqueous solution in some cases.

Other components of the coprecipitation synthesis apparatus 170 illustrated in FIG. 3 are described. The coprecipitation synthesis apparatus 170 includes a stirrer 172, a stirrer motor 173, a thermometer 174, a tank 175, a tube 176, a pump 177, a tank 180, a tube 181, a pump 182, a tank 186, a tube 187, a pump 188, and a control device 190.

The stirrer 172 can stir the aqueous solution 192 in the reaction vessel 171, and the stirrer motor 173 is included as a power source that makes the stirrer 172 rotate. The stirrer 172 includes a paddle-type agitator blade (denoted as a paddle blade), and the paddle blade includes two to six blades. The blade may have an inclination of greater than or equal to 40 degrees and less than or equal to 70 degrees.

The thermometer 174 can measure the temperature of the aqueous solution 192. The temperature of the reaction vessel 171 can be controlled using a thermoelectric element such that the temperature of the aqueous solution 192 is constant. An example of the thermoelectric element is a Peltier element. Although not shown, a pH meter is also provided in the reaction vessel 171, and the pH of the aqueous solution 192 can be measured.

Different aqueous solutions of source materials can be pooled in the tanks. For example, the tanks can be filled with the mixed solution 901 and the aqueous solution 892. A tank filled with the aqueous solution 894 serving as a filling liquid may be prepared. Each tank is equipped with a pump and an aqueous solution of a source material can be dropped into the reaction vessel 171 through a tube with use of the pump. The dropping amount of the aqueous solution of a source material, that is the amount of the delivered liquid, can be controlled with the pump. In addition to the pump, a valve may be provided for the tube 176, and the dropping amount of the aqueous solution of the source material, i.e., the amount of the delivered liquid may be controlled with the valve.

The control device 190 is electrically connected to the stirrer motor 173, the thermometer 174, the pump 177, the pump 182, and the pump 188, and can control the number of rotations of the stirrer 172, the temperature of the aqueous solution 192, and the dropping amounts of the aqueous solutions of source materials.

The number of rotations of the stirrer 172, specifically, the number of rotations of the paddle blade is preferably, for example, greater than or equal to 800 rpm and less than or equal to 1200 rpm. The stirring is preferably performed while the aqueous solution 192 is heated at a temperature higher than or equal to 50° C. and lower than or equal to 90° C. In the stirring, the mixed solution 901 is preferably dropped into the reaction vessel 171 at a constant rate. Needless to say, the rotation number of the paddle blade is not limited to a constant number, and can be appropriately adjusted. For example, the rotation number can be changed depending on the liquid amount of the reaction vessel 171. Moreover, the dropping rate of the mixed solution 901 can be adjusted. The dropping rate can be controlled to keep the pH of the reaction vessel 171 constant. The dropping rates may be controlled so that the aqueous solution 892 is dropped when the pH varies from a desired pH value during the dropping of the mixed solution 901. The pH value is greater than or equal to 9.0 and less than or equal to 11.0, preferably greater than or equal to 9.8 and less than or equal to 10.3.

Through the above process, a reaction product is precipitated in the reaction vessel 171. The reaction product includes a cobalt compound. This reaction can be referred to as coprecipitation or co-precipitation, and this step is referred to as a coprecipitation step in some cases.

This embodiment can be freely combined with the other embodiments.

### Embodiment 4

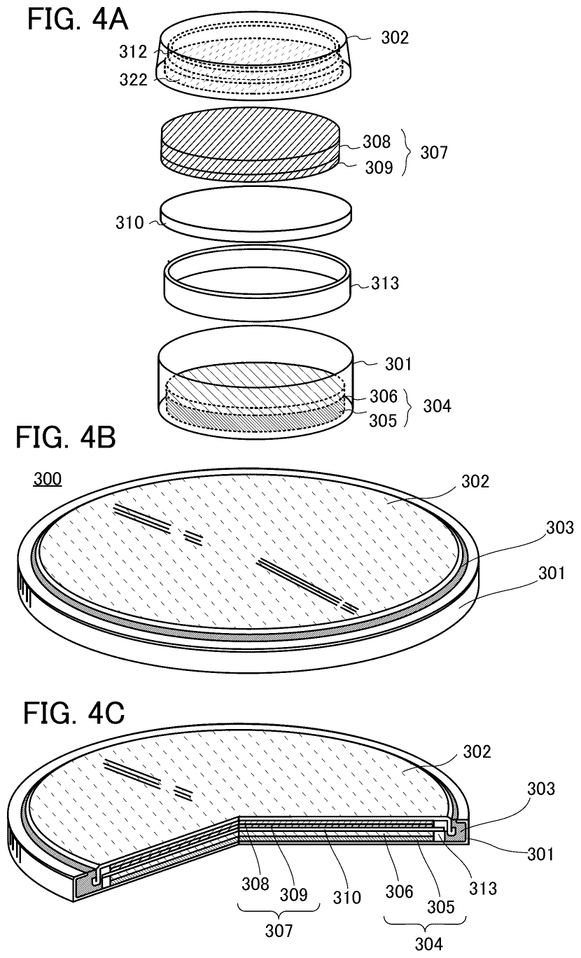

An example of a coin-type secondary battery is described. FIG. 4A is an exploded perspective view of a coin-type (single-layer flat type) secondary battery, FIG. 4B is an external view thereof, and FIG. 4C is a cross-sectional view thereof. Coin-type secondary batteries are mainly used in small electronic devices. In this specification, coin-type batteries include button-type batteries.

FIG. 4A is a schematic view showing overlap (a vertical relation and a positional relation) between components for easy understanding. Thus, FIG. 4A and FIG. 4B do not completely correspond with each other.

In FIG. 4A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 4A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 4B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to a liquid electrolyte, such as nickel, aluminum, or titanium, an alloy of such a metal, or an alloy of such a metal and another metal (e.g., stainless steel) can be used. Covering with nickel and aluminum is preferable in order to prevent corrosion due to the liquid electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the liquid electrolyte; as illustrated in FIG. 4C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

With the above-described structure, the coin-type secondary battery 300 can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

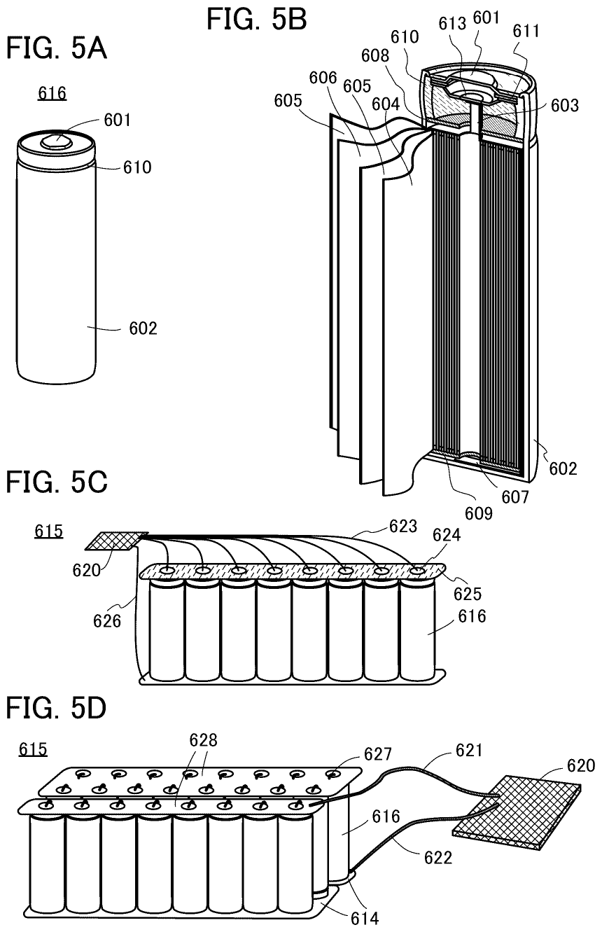

An example of a cylindrical secondary battery is described with reference to FIG. 5A. As illustrated in FIG. 5A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 5B schematically illustrates across section of a cylindrical secondary battery. The cylindrical secondary battery illustrated in FIG. 5B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 located therebetween is provided. Although not illustrated, the battery element is wound around a central axis. One end of the battery can 602 is close and the other end thereof is open. For the battery can 602, a metal having corrosion resistance to a liquid electrolyte, typified by nickel, aluminum, or titanium, an alloy of such a metal, and an alloy of such a metal and another metal (e.g., stainless steel) can be used. The battery can 602 is preferably covered with nickel and aluminum in order to prevent corrosion due to the liquid electrolyte. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 5A to FIG. 5D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 200A described in Embodiment 1 or the positive electrode active material 200B described in Embodiment 2 is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material of aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

FIG. 5C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used.

FIG. 5D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 5D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

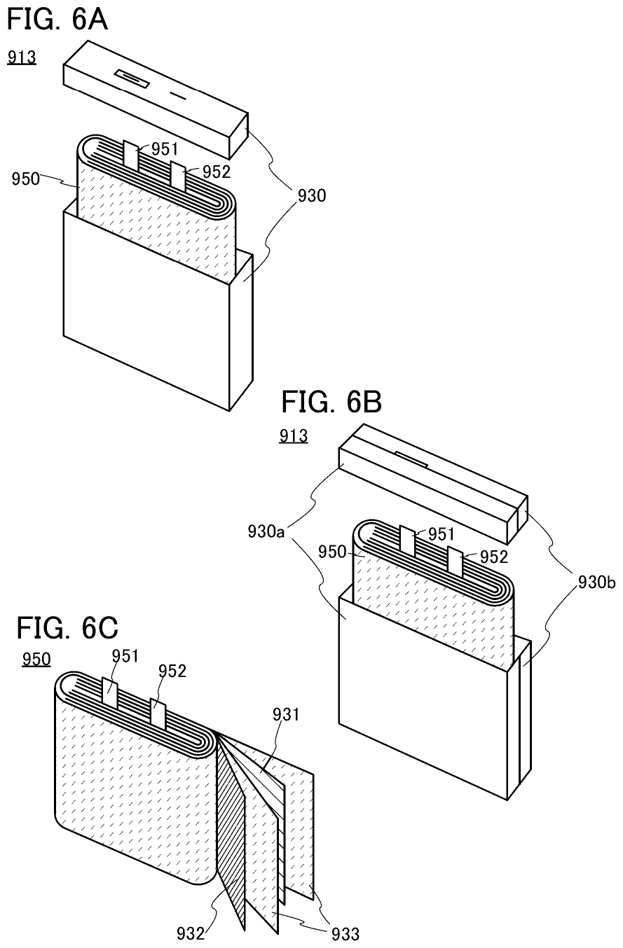

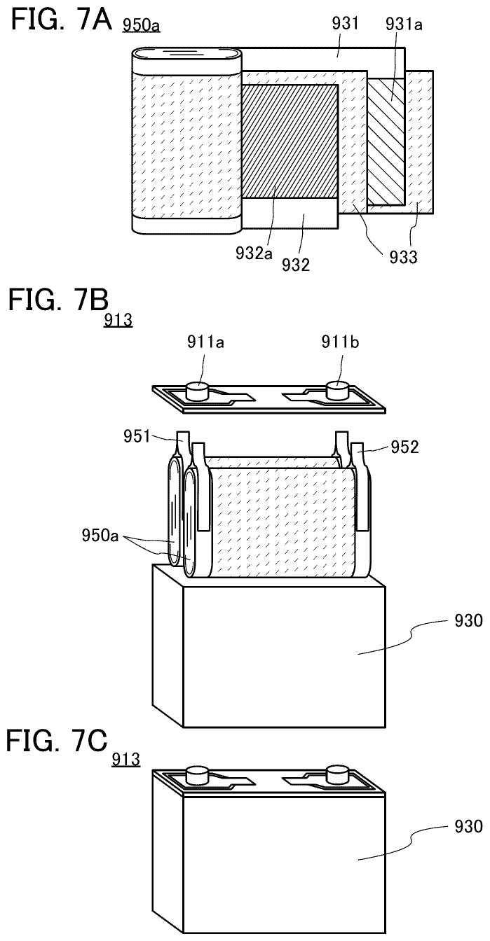

Structure examples of secondary batteries are described with reference to FIG. 6 and FIG. 7.

A secondary battery 913 illustrated in FIG. 6A includes a wound body 950 provided with a terminal 951 and a terminal 952 inside a housing 930. The wound body 950 is immersed in a liquid electrolyte inside the housing 930. The terminal 952 is in contact with the housing 930. The use of an insulator inhibits contact between the terminal 951 and the housing 930. Note that in FIG. 6A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 6B, the housing 930 illustrated in FIG. 6A may be formed using a plurality of materials. For example, in the secondary battery 913 illustrated in FIG. 6B, a housing 930a and a housing 930b are attached to each other, and the wound body 950 is provided in a region surrounded by the housing 930a and the housing 930b.

For the housing 930a, an insulating material of an organic resin can be used. In particular, when an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 6C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 7A to FIG. 7C, the secondary battery 913 may include a wound body 950a. The wound body 950a illustrated in FIG. 7A includes the negative electrode 931, the positive electrode 932, and the separators 933. The negative electrode 931 includes a negative electrode active material layer 931a. The positive electrode 932 includes a positive electrode active material layer 932a.

The positive electrode active material 200A described in Embodiment 1 or the positive electrode active material 200B described in Embodiment 2 is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 7B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 7C, the wound body 950a and a liquid electrolyte are covered with the housing 930, whereby the secondary battery 913 is completed. The housing 930 is preferably provided with a safety valve and an overcurrent protection element. In order to prevent the battery from exploding, a safety valve is a valve to be released when the internal pressure of the housing 930 reaches a predetermined pressure.

As illustrated in FIG. 7B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 6A to FIG. 6C can be referred to for the other components of the secondary battery 913 illustrated in FIG. 7A and FIG. 7B.

### <Laminated Secondary Battery>

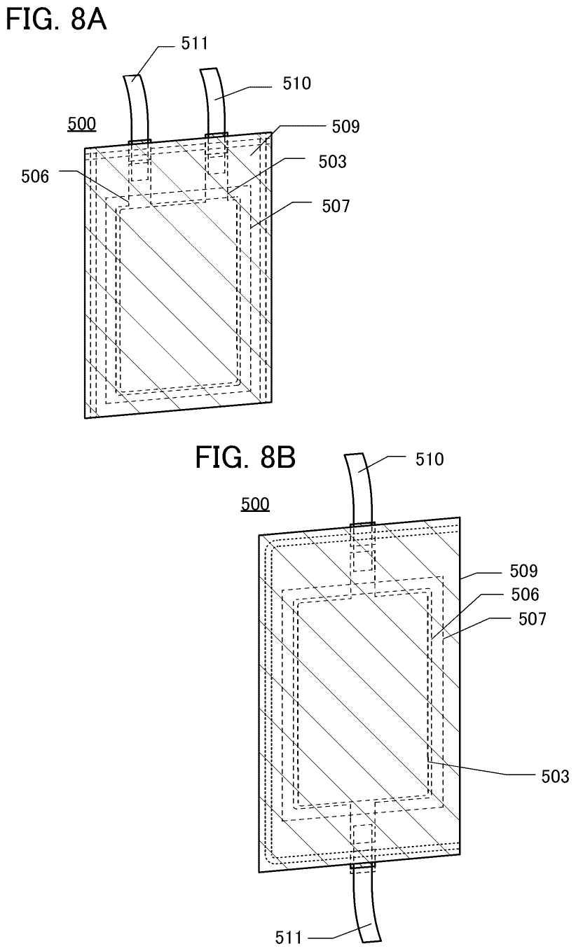

Next, examples of the appearance of a laminated secondary battery are illustrated in FIG. 8A and FIG. 8B. In FIG. 8A and FIG. 8B, a positive electrode 503, a negative electrode 506, a separator 507, an exterior body 509, a positive electrode lead electrode 510, and a negative electrode lead electrode 511 are included.

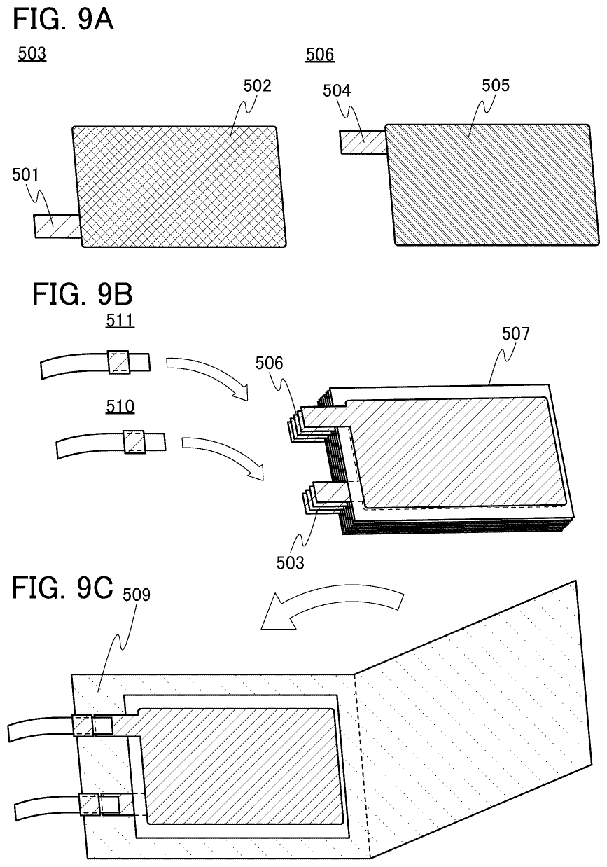

FIG. 9A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 9A.

### <Method for Fabricating Laminated Secondary Battery>

Here, an example of a method for fabricating the laminated secondary battery whose external view is shown in FIG. 8A is described with reference to FIG. 9B and FIG. 9C.

First, the negative electrode 506, the separator 507, and the positive electrode 503 are stacked. FIG. 9B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 9C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that a liquid electrolyte can be introduced later.

Next, the liquid electrolyte (not illustrated) is introduced into the exterior body 509 from the inlet of the exterior body 509. The liquid electrolyte is preferably introduced in a reduced pressure atmosphere or in an inert atmosphere. Lastly, the inlet is sealed by bonding. In this manner, the laminated secondary battery 500 can be fabricated.

The positive electrode active material 200A described in Embodiment 1 or the positive electrode active material 200B described in Embodiment 2 is used for the positive electrode 503, whereby the secondary battery 500 can have high capacity, high charge and discharge capacity, and excellent cycle performance.

### [Examples of Battery Pack]

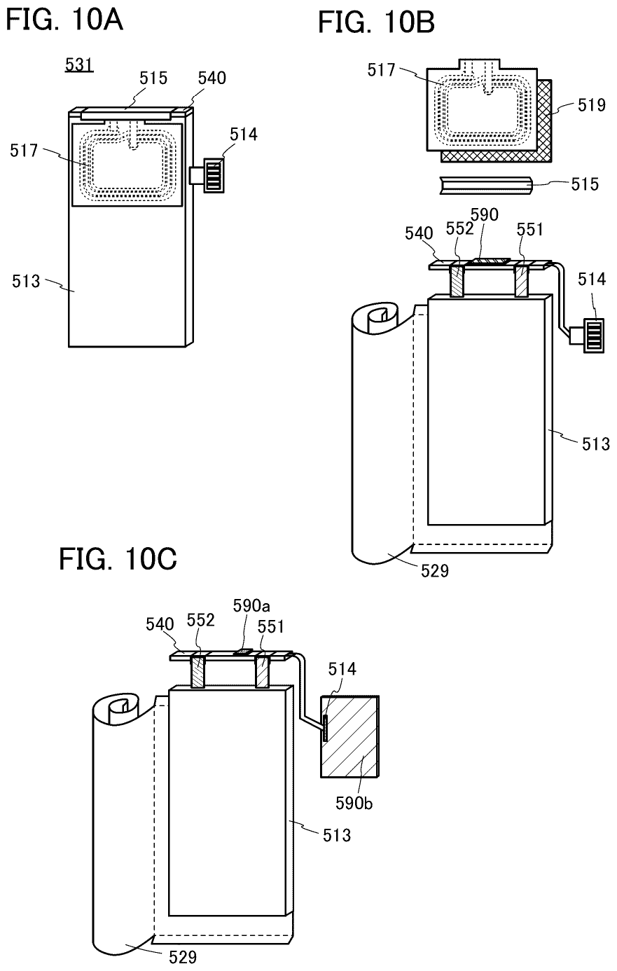

Examples of a secondary battery pack of one embodiment of the present invention that is capable of wireless charging using an antenna will be described with reference to FIG. 10A to FIG. 10C.

FIG. 10A is a diagram illustrating the appearance of a secondary battery pack 531 that has a rectangular solid shape with a small thickness (also referred to as a flat plate shape with a certain thickness). FIG. 10B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 10B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 10C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, an antenna typified by a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents of this embodiment can be freely combined with the contents of the other embodiments.

### Embodiment 5

In this embodiment, an example in which an all-solid-state battery is fabricated using the positive electrode active material 200A described in Embodiment 1 or the positive electrode active material 200B described in Embodiment 2 will be described.

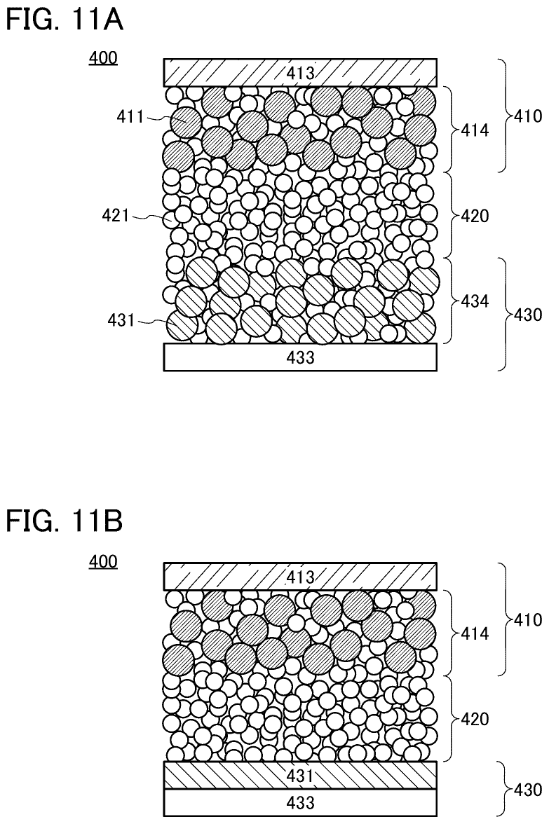

As illustrated in FIG. 11A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 200A described in Embodiment 1 or the positive electrode active material 200B described in Embodiment 2 is used as the positive electrode active material 411. The positive electrode active material layer 414 may include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used as the negative electrode active material 431, metal lithium does not need to be processed into particles; thus, the negative electrode 430 that does not include the solid electrolyte 421 can be formed, as illustrated in FIG. 11B. FIG. 11B illustrates an example in which the negative electrode active material 431 is deposited by a sputtering method. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (Li₁₀GeP₂S₁₂ or Li_{3.25}Ge_{0.25}P_{0.75}S₄), sulfide glass (70Li₂S.30P₂S₅, 30Li₂S.26B₂S₃.44LiI, 63Li₂S.36SiS₂.1Li₃PO₄, 57Li₂S.38SiS₂.5Li₄SiO₄, or 50Li₂S.50GeS₂), or sulfide-based crystallized glass (Li₇P₃S₁₁ or Li_{3.25}P_{0.95}S₄). The sulfide-based solid electrolyte has advantages of high conductivity of some materials, low-temperature synthesis, and ease of maintaining a path for electrical conduction after charge and discharge because of its relative softness.

The oxide-based solid electrolyte includes a material with a perovskite crystal structure (La_{2/3-x}Li₃ₓTiO₃), a material with a NASICON crystal structure (Li_{1-y}Al_{y}Ti_{2-y}(PO₄)₃), a material with a garnet crystal structure (Li₇La₃Zr₂O₁₂), a material with a LISICON crystal structure (Li₁₄ZnGe₄O₁₆), LLZO (Li₇La₃Zr₂O₁₂), oxide glass (Li₃PO₄—Li₄SiO₄ or 50Li₄SiO₄.50Li₃BO₃), or oxide-based crystallized glass (Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

The halide-based solid electrolyte includes LiAlCl₄, LiInBr₆, LiF, LiCl, LiBr, or LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0[x[1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification, a NASICON crystal structure refers to a compound that is represented by M₂(XO₄)₃ (M: transition metal; X: S, P, As, Mo, or W) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

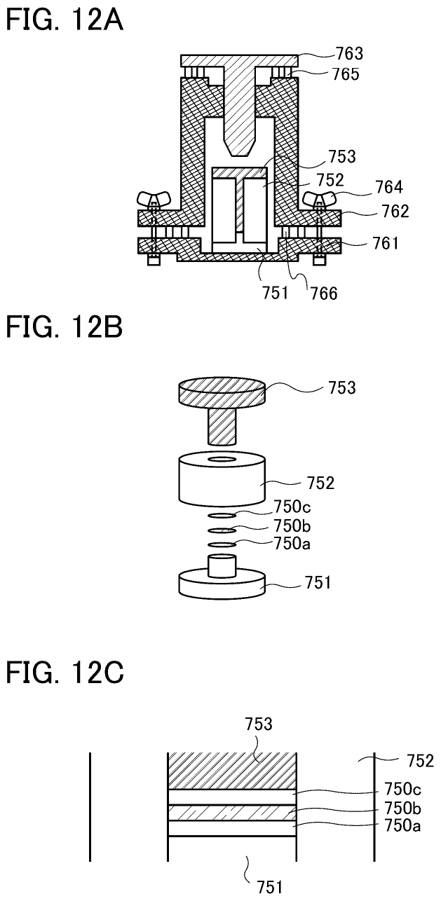

FIG. 12 illustrates an example of a cell for evaluating materials of an all-solid-state battery, for example.

FIG. 12A is a cross-sectional schematic view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 12B is an enlarged perspective view of the evaluation material and its vicinity.

A stack of a positive electrode 750a, a solid electrolyte layer 750b, and a negative electrode 750c is illustrated here as an example of the evaluation material, and its cross-sectional view is illustrated in FIG. 12C. Note that the same portions in FIG. 12A to FIG. 12C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

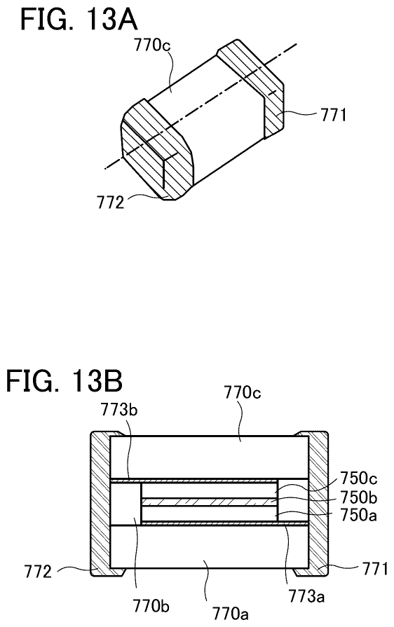

FIG. 13A illustrates a perspective view of a secondary battery of one embodiment of the present invention that has an exterior body and a shape different from those in FIG. 12. The secondary battery in FIG. 13A includes external electrodes 771 and 772 and is sealed with an exterior body including a plurality of package components.

FIG. 13B illustrates an example of a cross section along the dashed-dotted line in FIG. 13A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 200A described in Embodiment 1 or the positive electrode active material 200B described in Embodiment 2 can achieve an all-solid-state secondary battery having a high energy density and favorable output characteristics.

The contents of this embodiment can be combined with the contents of the other embodiments as appropriate.

### Embodiment 6

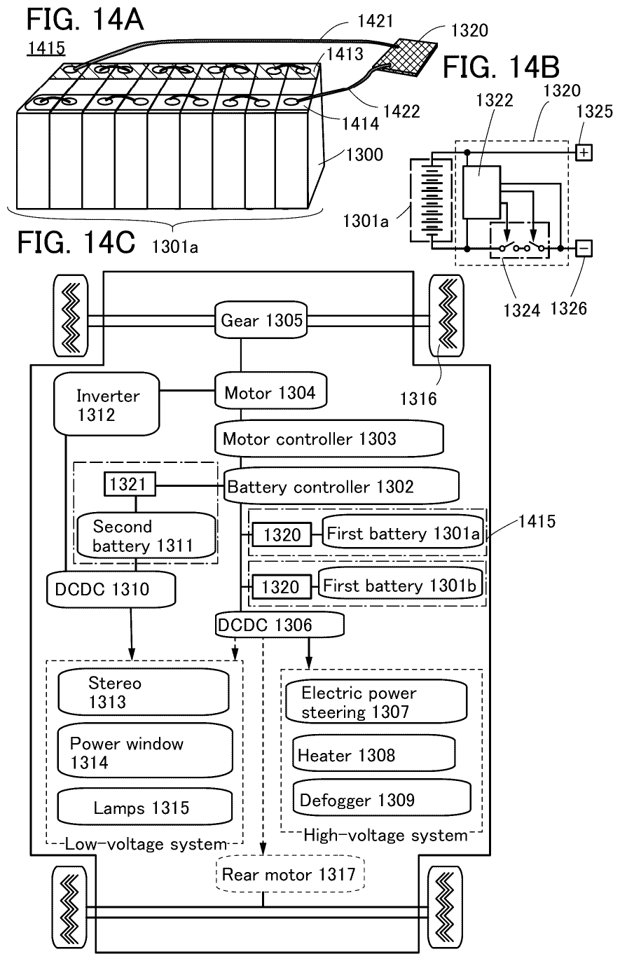

This embodiment is an example different from the cylindrical secondary battery of FIG. 5D. An example of application to an electric vehicle (EV) is described with reference to FIG. 14C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 6A or FIG. 7C or the stacked-layer structure illustrated in FIG. 8A or FIG. 8B. Alternatively, the first battery 1301a may be the all-solid-state battery in Embodiment 5. The use of the all-solid-state battery in Embodiment 5 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (an electric power steering 1307, a heater 1308, and a defogger 1309) through a DCDC 1306. Even in the case where there is a rear motor 1317 for rear wheels, the first battery 1301a is used to rotate the rear motor 1317.

The second battery 1311 supplies electric power to in-vehicle parts for 14 V (a stereo 1313, a power window 1314, and lamps 1315) through a DCDC 1310.

The first battery 1301a will be described with reference to FIG. 14A.

FIG. 14A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (a road surface), the plurality of secondary batteries are preferably fixed by the fixing portions 1413 and 1414 and a battery container box. Furthermore, the one electrode is electrically connected to a control circuit portion 1320 through a wiring 1421. The other electrode is electrically connected to the control circuit portion 1320 through a wiring 1422.

FIG. 14B illustrates an example of a block diagram of the battery pack 1415 illustrated in FIG. 14A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside and the upper limit of output current to the outside. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), or GaOx (gallium oxide, where x is a real number greater than 0).

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium-ion secondary batteries in that they have a larger amount of self-discharge and are more likely to deteriorate due to a phenomenon called sulfation. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 3 may be used. The use of the all-solid-state battery in Embodiment 3 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging.

The battery controller 1302 can set the charge voltage and charge current of the first batteries 1301a and 1301b. The battery controller 1302 can set charge conditions in accordance with charge characteristics of a secondary battery to be used, so that fast charge can be performed.

Although not illustrated, in the case of connection to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations have a 100 V outlet, a 200 V outlet, or a three-phase 200 V outlet with 50 kW. Furthermore, charge can be performed with electric power supplied from external charge equipment by a contactless power feeding method.

For fast charge, secondary batteries that can withstand high-voltage charge have been desired to perform charge in a short time.

The above-described secondary battery in this embodiment uses the positive electrode active material 200A described in Embodiment 1 or the positive electrode active material 200B described in Embodiment 2. Moreover, it is possible to achieve a secondary battery in which graphene is used as a conductive additive, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above-described secondary battery in this embodiment, the use of the positive electrode active material 200A described in Embodiment 1 or the positive electrode active material 200B described in Embodiment 2 can increase the operating voltage of the secondary battery, and the increase in charge voltage can increase the available capacity. Moreover, using the positive electrode active material 200A described in Embodiment 1 or the positive electrode active material 200B described in Embodiment 2 in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 5D, FIG. 7C, and FIG. 14A on vehicles can achieve next-generation clean energy vehicles typified by hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

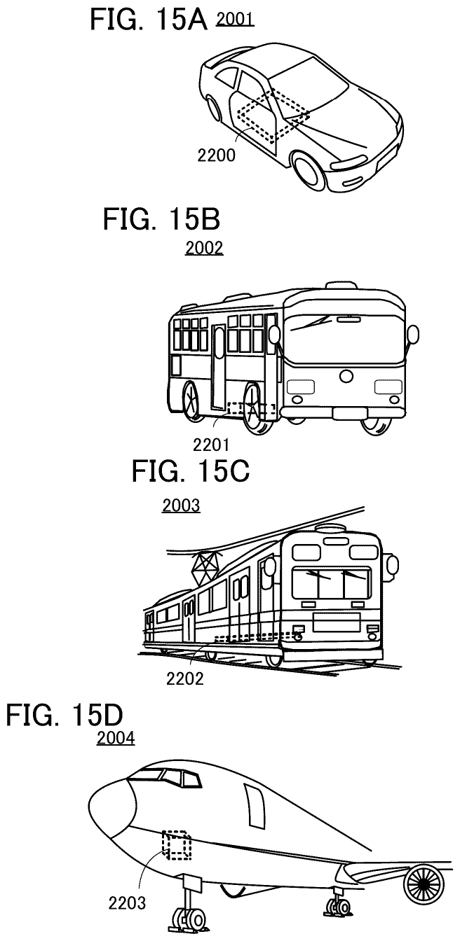

FIG. 15A to FIG. 15D illustrate examples of transport vehicles using one embodiment of the present invention. A motor vehicle 2001 illustrated in FIG. 15A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 4 is provided at one position or several positions. The motor vehicle 2001 illustrated in FIG. 15A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system or a contactless charge system. In charging, a given method such as CHAdeMO (registered trademark) or Combined Charging System may be employed as a charge method and the standard of a connector, as appropriate. A charging device may be a charging station provided in a commerce facility or a power source in a house. For example, with the use of the plug-in system, the power storage device mounted on the motor vehicle 2001 can be charged by being supplied with electric power from the outside. Charge can be performed by converting AC power into DC power through a converter typified by an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 15B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 15A except for the number of secondary batteries configuring the secondary battery module; thus, the description is omitted.

FIG. 15C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. With the use of a secondary battery including a positive electrode using the positive electrode active material 200A described in Embodiment 1 or the positive electrode active material 200B described in Embodiment 2, a secondary battery having excellent rate performance and charge and discharge cycle performance can be manufactured, which can contribute to higher performance and a longer lifetime of the transport vehicle 2003. A battery pack 2202 has the same function as that in FIG. 15A except for the number of secondary batteries configuring the secondary battery module; thus, the description is omitted.

FIG. 15D illustrates an aircraft 2004 having a combustion engine as an example. The aircraft 2004 illustrated in FIG. 15D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 15A except for the number of secondary batteries configuring the secondary battery module; thus, the description is omitted.

The contents of this embodiment can be combined with the contents of the other embodiments as appropriate.

### Embodiment 7

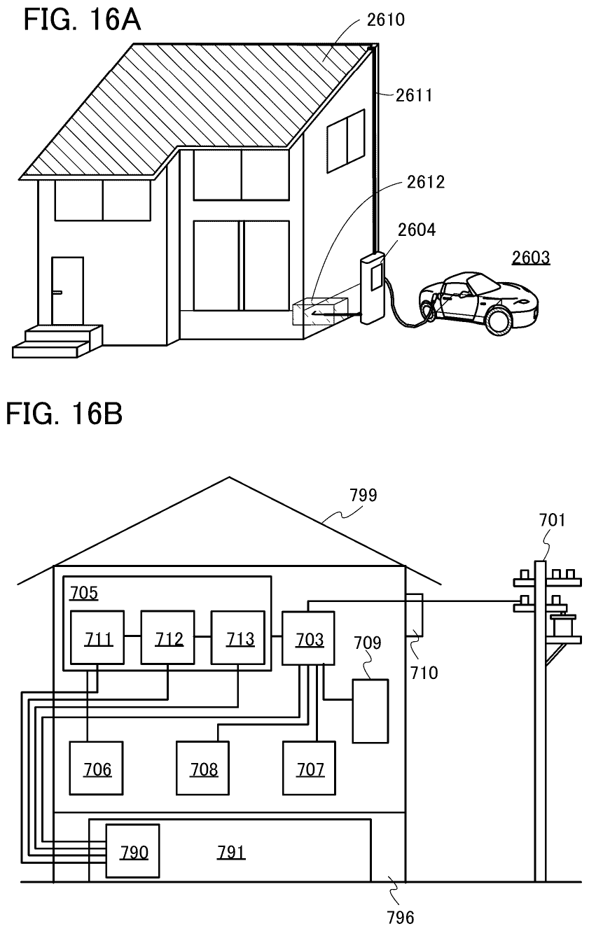

In this embodiment, examples in which the secondary battery of one embodiment of the present invention is mounted on a building will be described with reference to FIG. 16A and FIG. 16B.

A house illustrated in FIG. 16A includes a power storage device 2612 including the secondary battery of one embodiment of the present invention and a solar panel 2610. The power storage device 2612 is electrically connected to the solar panel 2610 through a wiring 2611. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure.

FIG. 16B illustrates an example of a power storage device of one embodiment of the present invention. As illustrated in FIG. 16B, a power storage device 791 of one embodiment of the present invention is provided in an underfloor space 796 of a building 799. The power storage device 791 may be provided with the control circuit described in Embodiment 6, and the use of a secondary battery including a positive electrode using the positive electrode active material 200A described in Embodiment 1 or the positive electrode active material 200B described in Embodiment 2 enables the power storage device 791 to have a long lifetime.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device typified by a TV or a personal computer. The power storage load 708 is, for example, an electric device typified by a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device typified by a TV or a personal computer through the router 709. Furthermore, it can be checked with a portable electronic terminal typified by a smartphone or a tablet through the router 709. With the indicator 706, the electric device, or the portable electronic terminal, for example, the demand for electric power depending on a time period (or per hour) that is predicted by the predicting portion 712 can be checked.

The contents of this embodiment can be combined with the contents of the other embodiments as appropriate.

### Embodiment 8

In this embodiment, examples in which a motorcycle or a bicycle is provided with the power storage device of one embodiment of the present invention will be described.

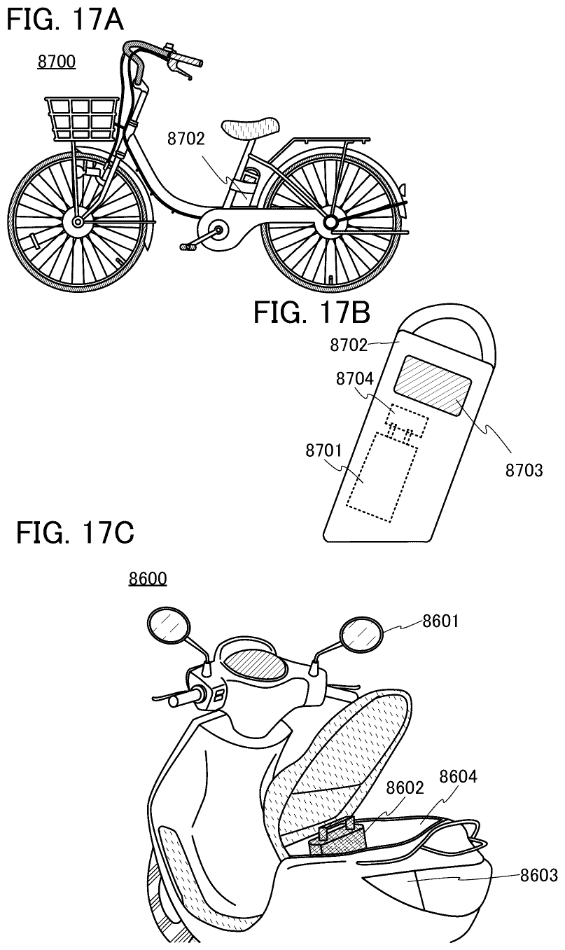

FIG. 17A illustrates an example of an electric bicycle using the power storage device of one embodiment of the present invention. The power storage device of one embodiment of the present invention can be used for an electric bicycle 8700 illustrated in FIG. 17A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 17B illustrates the state where the power storage device 8702 is detached from the bicycle. A plurality of storage batteries 8701 included in the power storage device of one embodiment of the present invention are incorporated in the power storage device 8702, and the remaining battery capacity can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may be provided with the small solid-state secondary battery illustrated in FIG. 13A and FIG. 13B. When the small solid-state secondary battery illustrated in FIG. 13A and FIG. 13B is provided in the control circuit 8704, electric power can be supplied to store data in a memory circuit included in the control circuit 8704 for along time. When the control circuit 8704 is used in combination with the secondary battery using the positive electrode active material 200A described in Embodiment 1 or the positive electrode active material 200B described in Embodiment 2 in the positive electrode, the synergy on safety can be obtained.

FIG. 17C illustrates an example of a motorcycle using the power storage device of one embodiment of the present invention. A motor scooter 8600 illustrated in FIG. 17C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 200A described in Embodiment 1 or the positive electrode active material 200B described in Embodiment 2 can have high capacity and contribute to a reduction in size.

In the motor scooter 8600 illustrated in FIG. 17C, the power storage device 8602 can be stored in an under-seat storage unit 8604. The power storage device 8602 can be stored in the under-seat storage unit 8604 even with a small size.

The contents of this embodiment can be combined with the contents of the other embodiments as appropriate.

### Embodiment 9

In this embodiment, examples of electronic devices each including the secondary battery of one embodiment of the present invention will be described. Examples of the electronic device including the secondary battery include a television device (also referred to as a television or a television receiver), a monitor for a computer, a digital camera, a digital video camera, a digital photo frame, a mobile phone (also referred to as a cellular phone or a mobile phone device), a portable game machine, a portable information terminal, an audio reproducing device, and a large-sized game machine typified by a pachinko machine. Examples of the portable information terminal include a laptop personal computer, a tablet terminal, an e-book reader, and a mobile phone.

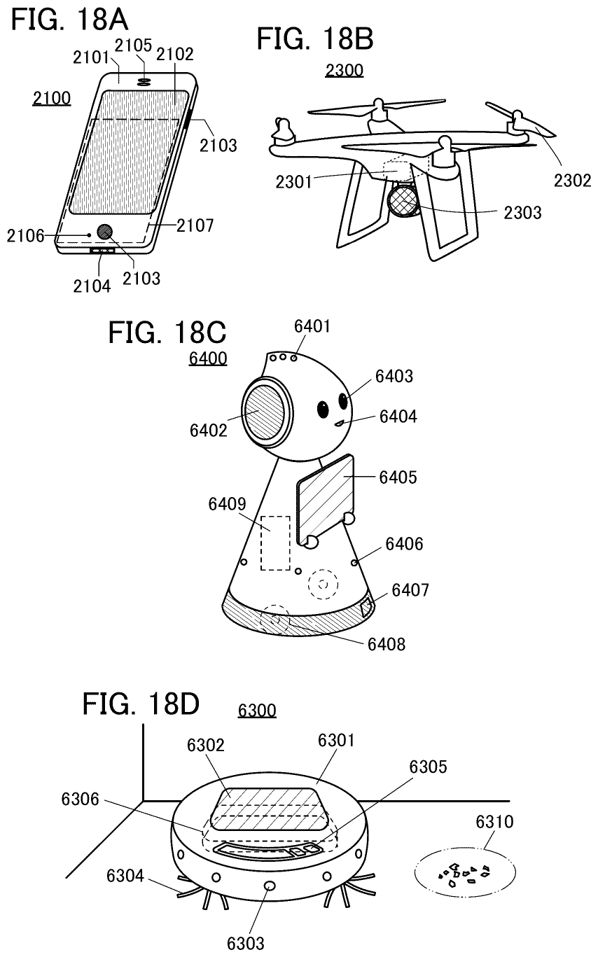

FIG. 18A illustrates an example of a mobile phone. A mobile phone 2100 includes a housing 2101 in which a display portion 2102 is incorporated, operation buttons 2103, an external connection port 2104, a speaker 2105, or a microphone 2106. The mobile phone 2100 includes a secondary battery 2107. The use of the secondary battery 2107 including a positive electrode using the positive electrode active material 200A described in Embodiment 1 or the positive electrode active material 200B described in Embodiment 2 achieves high capacity and a structure that accommodates space saving due to a reduction in size of the housing.

The mobile phone 2100 is capable of executing a variety of applications typified by mobile phone calls, e-mailing, viewing and editing texts, music reproduction, Internet communication, and a computer game.

With the operation button 2103, a variety of functions typified by time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor typified by a fingerprint sensor, a pulse sensor, or a temperature sensor, a touch sensor, a pressure sensitive sensor, or an acceleration sensor is preferably mounted, for example.

FIG. 18B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 200A described in Embodiment 1 or the positive electrode active material 200B described in Embodiment 2 has high energy density and a high level of safety, and thus can be used safely for a long time over a long period of time and is preferable as the secondary battery included in the unmanned aircraft 2300.

FIG. 18C illustrates an example of a robot. A robot 6400 illustrated in FIG. 18C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, and an arithmetic device.

The microphone 6402 has a function of detecting a speaking voice of a user and an environmental sound. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 200A described in Embodiment 1 or the positive electrode active material 200B described in Embodiment 2 has high energy density and a high level of safety, and thus can be used safely for a long time over a long period of time and is preferable as the secondary battery 6409 included in the robot 6400.

FIG. 18D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, or a variety of sensors. Although not illustrated, the cleaning robot 6300 is provided with a tire or an inlet. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, typified by a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 200A described in Embodiment 1 or the positive electrode active material 200B described in Embodiment 2 has high energy density and a high level of safety, and thus can be used safely for a long time over a long period of time and is preferable as the secondary battery 6306 included in the cleaning robot 6300.

The contents of this embodiment can be combined with the contents of the other embodiments as appropriate.

### Example

In this example, a cobalt compound containing nickel, cobalt, and manganese at an element ratio Ni:Co:Mn=8:1:1 was obtained by a coprecipitation method in accordance with Embodiment 1, and then lithium and aluminum were added. After lithium was added and mixed, first heat treatment was performed at 500° C. for 10 hours, the temperature was returned to room temperature and crushing was performed, and then second heat treatment was performed at 800° C. for 10 hours. Then, aluminum was added and third heat treatment was performed at 800° C. for 2 hours. NCMA was obtained by adding Al at 1 atm % with respect to the total of nickel, manganese, cobalt, and oxygen.

As a comparative example, NCM was obtained in such a manner that after a cobalt compound containing nickel, cobalt, and manganese at an element ratio Ni:Co:Mn=8:1:1 was obtained by a coprecipitation method in accordance with Embodiment 1, lithium was added and mixed and then heat treatment was performed at 800° C. for 10 hours. The average particle diameter of the comparative example (NCM) is 11 μm.

The average particle diameter of this example (NCMA) is 9.6 μm.

A plurality of coin-type battery cells were fabricated using the positive electrode active material of this example (NCMA), and their cycle performance was evaluated.

The positive electrode active material obtained by the method described in Embodiment 1 was used as positive electrode active materials of the samples. Acetylene black was used as a conductive additive, mixing was performed to form a slurry, and the slurry was applied onto a current collector of aluminum.

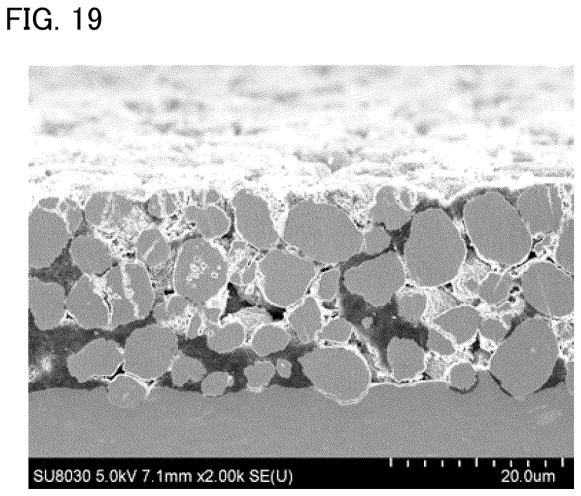

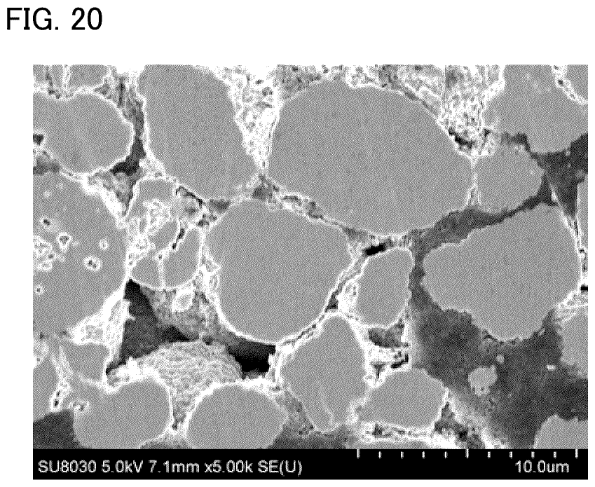

After the slurry was applied onto the current collector, a solvent was volatilized. After that, pressure was applied at 210 kN/m, and then pressure was further applied at 1467 kN/m. Through the above process, the positive electrode was obtained. The loading amount of the positive electrode was approximately 7 mg/cm². FIG. 19 is a photograph of an observed cross section of part of the positive electrode. FIG. 20 is an enlarged photograph of part of FIG. 19.

Using the formed positive electrodes, CR2032 type coin-type battery cells (a diameter of 20 mm, a height of 3.2 mm) were fabricated.

A lithium metal was used for a counter electrode.

As an electrolyte of the samples, 1 mol/L of lithium hexafluorophosphate (LiPF₆) was used, and ethylene carbonate (EC) and diethyl carbonate (DEC) were mixed at EC:DEC=3:7 (volume ratio). Furthermore, vinylene carbonate (VC) was added as an additive at 2 wt % with respect to the total solvent mixed above.

As a separator, 25-μm-thick polypropylene was used.

A positive electrode can and a negative electrode can that were formed using stainless steel (SUS) were used.

In the evaluation of the cycle performance, the charge voltage was set at 4.5 V, and the temperature of a constant-temperature unit in which the half cell was placed was set at 45° C. Charge was performed by constant current (CC)/constant voltage (CV) at a rate of 0.5 C (1 C was 200 mA/g) and finished when the rate was 0.05 C. Discharge was performed by constant current (CC) at a rate of 0.5 C (1 C was 200 mA/g) and finished when the voltage was 2.5 V. Downtime may be provided between the discharge and the next charge; a 10-minute downtime was provided in this example. As a cycle test for evaluating the cycle performance, the charge and the discharge described above were repeated 100 times.

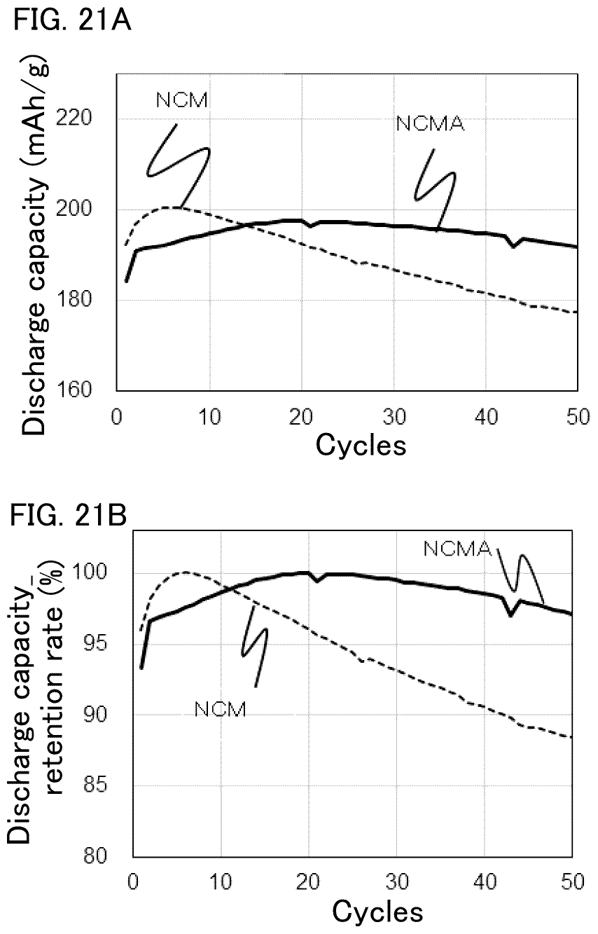

FIG. 21A and FIG. 21B illustrate cycle performance at a measurement temperature of 25° C. The vertical axis in FIG. 21A represents the discharge capacity, and the vertical axis in FIG. 21B represents the discharge capacity retention rate.

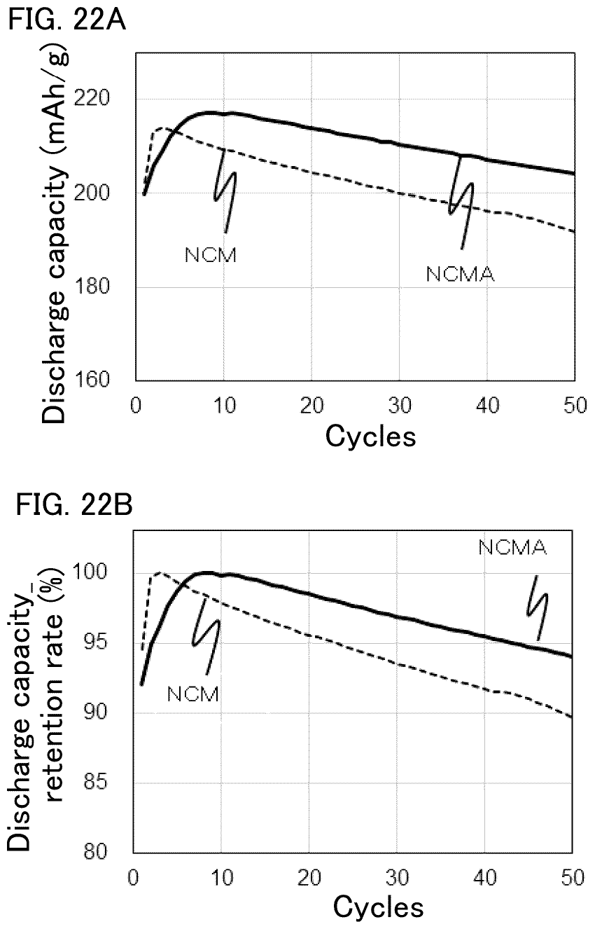

FIG. 22A and FIG. 22B illustrate cycle performance at a measurement temperature of 45° C. The vertical axis in FIG. 22A represents the discharge capacity, and the vertical axis in FIG. 22B represents the discharge capacity retention rate.

Note that the comparative example in FIG. 22A and FIG. 22B is NCM containing nickel, cobalt, and manganese with an element ratio Ni:Co:Mn=8:1:1.

From the results of FIG. 21B, it was confirmed that NCMA, the positive electrode active material with higher crushing strength than that of NCM of the comparative example, has a high capacity retention rate in the charge cycles.

### REFERENCE NUMERALS

170: coprecipitation synthesis apparatus, 171: reaction vessel, 172: stirrer, 173: stirrer motor, 174: thermometer, 175: tank, 176: tube, 177: pump, 180: tank, 181: tube, 182: pump, 186: tank, 187: tube, 188: pump, 190: control device, 192: aqueous solution, 200A: positive electrode active material, 200B: positive electrode active material, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 400: secondary battery, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 513: secondary battery, 514: terminal, 515: sealant, 517: antenna, 519: layer, 529: label, 531: secondary battery pack, 540: circuit board, 551: one, 552: the other, 590: control circuit, 590a: circuit system, 590b: circuit system, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 750a: positive electrode, 750b: solid electrolyte layer, 750c: negative electrode, 751: electrode plate, 752: insulating tube, 753: electrode plate, 761: lower component, 762: upper component, 764: butterfly nut, 765: O ring, 766: insulator, 770a: package component, 770b: package component, 770c: package component, 771: external electrode, 772: external electrode, 773a: electrode layer, 773b: electrode layer, 790: control device, 791: power storage device, 796: underfloor space, 799: building, 890: aqueous solution, 892: aqueous solution, 893: aqueous solution, 894: aqueous solution, 895: aqueous solution, 896: aqueous solution, 901: mixed solution, 902: mixed solution, 904: mixture, 905: mixture, 906: mixed solution, 908: mixture, 909: mixture, 910: compound, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1300: rectangular secondary battery, 1301a: battery, 1301b: battery, 1302: battery controller, 1303: motor controller, 1304: motor, 1305: gear, 1306: DCDC, 1307: electric power steering, 1308: heater, 1309: defogger, 1310: DCDC, 1311: battery, 1312: inverter, 1313: stereo, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: motor vehicle, 2002: transporter, 2003: transport vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charge equipment, 2610: solar pane, 2611: wiring, 2612: power storage device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 8600: motor scooter, 8601: side mirror, 8602: power storage device, 8603: indicator light, 8604: under-seat storage unit, 8700: electric bicycle, 8701: storage battery, 8702: power storage device, 8703: display portion, 8704: control circuit

1. A method for manufacturing a positive electrode active material, comprising:
supplying an aqueous solution in which a water-soluble nickel salt, a water-soluble cobalt salt, and a water-soluble manganese salt are dissolved and an alkaline solution to a reaction vessel and mixing the aqueous solution and the alkaline solution in the reaction vessel to precipitate a cobalt compound;
heating a first mixture of the cobalt compound and a lithium compound at a first temperature;
after the heated first mixture is ground or crushed, further performing heating at a second temperature being a temperature higher than the first temperature; and
heating a second mixture obtained by mixing the first mixture and an aluminum compound at a third temperature.

2. The method for manufacturing a positive electrode active material according to claim 1, wherein the third temperature is higher than the first temperature.

3. The method for manufacturing a positive electrode active material according to claim 1, further comprising:
supplying an aqueous solution containing magnesium to the reaction vessel.

4. The method for manufacturing a positive electrode active material according to claim 1, further comprising:
supplying an aqueous solution containing calcium to the reaction vessel.

5. The method for manufacturing a positive electrode active material according to claim 1, wherein the alkaline solution is an aqueous solution containing sodium hydroxide.

6. The method for manufacturing a positive electrode active material according to claim 1, wherein a pH of a mixed solution obtained by mixing the aqueous solution and the alkaline solution is greater than or equal to 9 and less than or equal to 11.

7. The method for manufacturing a positive electrode active material according to claim 1, wherein an aqueous solution containing glycine is added when the cobalt compound is precipitated by mixing the aqueous solution and the alkaline solution.

8. The method for manufacturing a positive electrode active material according to claim 1, wherein the first temperature is higher than or equal to 400° C. and lower than or equal to 700° C., and the second temperature is higher than 700° C. and lower than or equal to 1050° C.

9. The method for manufacturing a positive electrode active material according to claim 2, further comprising:
supplying an aqueous solution containing magnesium to the reaction vessel.

10. The method for manufacturing a positive electrode active material according to claim 2, further comprising:
supplying an aqueous solution containing calcium to the reaction vessel.

11. The method for manufacturing a positive electrode active material according to claim 2, wherein a pH of a mixed solution obtained by mixing the aqueous solution and the alkaline solution is greater than or equal to 9 and less than or equal to 11.

12. The method for manufacturing a positive electrode active material according to claim 3, wherein a pH of a mixed solution obtained by mixing the aqueous solution and the alkaline solution is greater than or equal to 9 and less than or equal to 11.

13. The method for manufacturing a positive electrode active material according to claim 4, wherein a pH of a mixed solution obtained by mixing the aqueous solution and the alkaline solution is greater than or equal to 9 and less than or equal to 11.

14. The method for manufacturing a positive electrode active material according to claim 2, wherein the first temperature is higher than or equal to 400° C. and lower than or equal to 700° C., and the second temperature is higher than 700° C. and lower than or equal to 1050° C.

15. The method for manufacturing a positive electrode active material according to claim 3, wherein the first temperature is higher than or equal to 400° C. and lower than or equal to 700° C., and the second temperature is higher than 700° C. and lower than or equal to 1050° C.

16. The method for manufacturing a positive electrode active material according to claim 4, wherein the first temperature is higher than or equal to 400° C. and lower than or equal to 700° C., and the second temperature is higher than 700° C. and lower than or equal to 1050° C.

17. The method for manufacturing a positive electrode active material according to claim 5, wherein the first temperature is higher than or equal to 400° C. and lower than or equal to 700° C., and the second temperature is higher than 700° C. and lower than or equal to 1050° C.

18. The method for manufacturing a positive electrode active material according to claim 6, wherein the first temperature is higher than or equal to 400° C. and lower than or equal to 700° C., and the second temperature is higher than 700° C. and lower than or equal to 1050° C.

19. The method for manufacturing a positive electrode active material according to claim 7, wherein the first temperature is higher than or equal to 400° C. and lower than or equal to 700° C., and the second temperature is higher than 700° C. and lower than or equal to 1050° C.
